(19) United States
(12) Patent Application Publication
(10) Pub. No.: US 2009/0300119 A1
(43) Pub. Date: Dec. 3, 2009

(54) BACKUP AND RESTORE FEATURE FOR MOBILE MESSAGING

(75) Inventor: Bao Nguyen, Aldie, VA (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: STEELCLOUD, INC., Herndon, VA (US)

(21) Appl. No.: 12/131,000

(22) Filed: May 30, 2008

(51) Int. Cl. G06F 15/16; G06F 15/177

(52) U.S. Cl. 709/206; 709/220

(57) ABSTRACT

Embodiments of the present invention address deficiencies of the art in respect to managing a mobile messaging server deployment and provide a method, system and computer program product for a backup and restore feature for a mobile messaging system. In an embodiment of the invention, a method for backup and restore in a mobile messaging system can be provided. The method can include deploying a mobile messaging system for use in cooperation with a communicatively coupled e-mail server and pushing e-mail from the e-mail server to wireless devices belonging to different subscribers through the mobile messaging system. The method also can include acquiring a snapshot of the deployed mobile messaging system exemplary of a contemporaneous state of the mobile messaging system, and storing the snapshot for subsequent retrieval and restoration of a subsequently prior state of the mobile messaging system.

### REFERENCE TO CO-PENDING APPLICATIONS FOR PATENT

The present application is related to the following co-assigned U.S. patent applications, which are expressly incorporated by reference herein:

U.S. application Ser. No. ______, entitled “FEDERATED MOBILE MESSAGING APPLIANCE” (docket no 7339-012U)), filed on May 30, 2008.

U.S. application Ser. No. ______, entitled “SUBSCRIBER AUDIT FEATURE FOR MOBILE MESSAGING” (docket no 7339-013U)), filed on May 30, 2008.

### BACKGROUND OF THE INVENTION

1. Field of the Invention

The present invention relates to the field of mobile messaging and more particularly to managing a mobile messaging system for delivering messages over the air to mobile messaging clients.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

E-mail has become so significant in the daily conduct of business that enterprise users no longer can tolerate e-mail access exclusively from within the enterprise. Rather, end users demand access even from remote locations, while traveling or at home. So reliant, in fact, end users have become upon e-mail, that end users no longer demonstrate the patience to access e-mail from traditional computing devices. Rather, e-mail users in the enterprise now demand access to e-mail 24/7/365 over wireless mobile communications devices like cellular telephones and personal digital assistants. Extreme compulsions to check e-mail constantly in a wireless device now have been diagnosed as a form of an obsessive-compulsive disorder.

Addressing the demand for wireless access to e-mail, traditional wireless carriers support both pull and push oriented e-mail messaging to wireless devices. One particularly successful mobile messaging technology—the Blackberry™ wireless messaging technology—provides over the air, push based messaging to a sophisticated end user wireless device, known as in the marketplace as the “Blackberry”. Alternatives to the Blackberry™ technology include the Good Technology messaging server and more recently, the Lotus Traveler™ service. In each of these mobile messaging technologies, a mobile messaging server is configured within the enterprise to cooperate with an e-mail server to deliver e-mail messages to subscribing wireless devices.

Generally, the mobile messaging server monitors the e-mail inbox in the e-mail server for each subscriber and upon detecting an inbound e-mail message, the mobile messaging server routes a copy to a corresponding wireless device over a wireless communications network. Conversely, e-mail messages composed within the wireless device of a subscriber are routed to the mobile messaging server which can place a copy within the e-mail server in the sent items folder for the subscriber. In this way, the subscriber maintains full access to e-mail (and even calendaring and contact information) irrespective of the location of the subscriber.

As it will be apparent, properly configuring the mobile messaging server is paramount to the successful performance of a mobile messaging system. Configuring a mobile messaging server for interoperation in the enterprise, however, is no small feat and requires substantial expertise. Configuration issues to be considered include the type of e-mail server, the network topology in which the mobile messaging server is to be deployed and components with whom the mobile messaging server is to interact, the number of subscribers to the mobile messaging service and the types of wireless devices used by the subscribers. So complicated has the configuration process become, that only the most sophisticated and well-funded organization can afford to deploy a mobile messaging service.

Yet further, once deployed, a mobile messaging solution requires careful management. From time to time, systems fail, either due to hardware faults, or program faults. Program faults can occur at the application level of the mobile messaging system, or the supporting operating system level, or in fact within any layer of dependent logic including device drivers and the like. Systems also fail due to incorrect configuration changes providing unexpected or unintended consequences. In many cases, a bundle of configuration changes may be applied while only a single one of those changes or a small combination of changes wreak havoc on the mobile messaging system. Restoring the mobile messaging to a stable state in all cases can be challenging, tedious and extraordinarily time consuming.

### BRIEF SUMMARY OF THE INVENTION

Embodiments of the present invention address deficiencies of the art in respect to managing a mobile messaging server deployment and provide a novel and non-obvious method, system and computer program product for a backup and restore feature for a mobile messaging system. In an embodiment of the invention, a method for backup and restore in a mobile messaging system can be provided. The method can include deploying a mobile messaging system for use in cooperation with a communicatively coupled e-mail server and pushing e-mail from the e-mail server to wireless devices belonging to different subscribers through the mobile messaging system. The method also can include acquiring a snapshot of the deployed mobile messaging system exemplary of a contemporaneous state of the mobile messaging system, and storing the snapshot for subsequent retrieval and restoration of a subsequently prior state of the mobile messaging system.

In another embodiment of the invention, a federated mobile messaging appliance can be provided. The appliance can include multiple different images stored within a hidden partition, each image of a mobile messaging system corresponding to a particular e-mail server type. The appliance yet further can include federated mobile messaging configuration logic including program code enabled to identify an e-mail server type for a coupled e-mail server, to select one of the images in the hidden partition based upon the identified e-mail server type, and to configure and activate a corresponding mobile messaging system for the selected one of the images for interoperation with the coupled e-mail server. Finally, the appliance can include backup and restore logic. The backup and restore logic can include program code enabled to acquire a snapshot of the deployed mobile messaging system exemplary of a contemporaneous state of the mobile messaging system, and to store the snapshot for subsequent retrieval and restoration of a subsequently prior state of the mobile messaging system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a mobile messaging system configured for backup and restore;

FIG. 2 is a flow chart illustrating a process for backup and restore in a mobile messaging system.

### DETAILED DESCRIPTION OF THE INVENTION

Embodiments of the present invention provide a method, system and computer program product for backup and restore in a mobile messaging system. In accordance with an embodiment of the present invention, a mobile messaging appliance can be configured with different, pre-configured images of a mobile messaging server, each image corresponding to a different type of e-mail server, but only one image of the mobile messaging server being deployed that corresponds to a detected e-mail server. Once deployed, the mobile messaging server can push e-mail messages from the e-mail server to wireless messaging devices for different subscribers via a mobile messaging service provider. Thereafter, a snapshot of the deployed mobile messaging system exemplary of a contemporaneous state of the mobile messaging system can be acquired, and stored for subsequent retrieval and restoration of a subsequently prior state of the mobile messaging system.

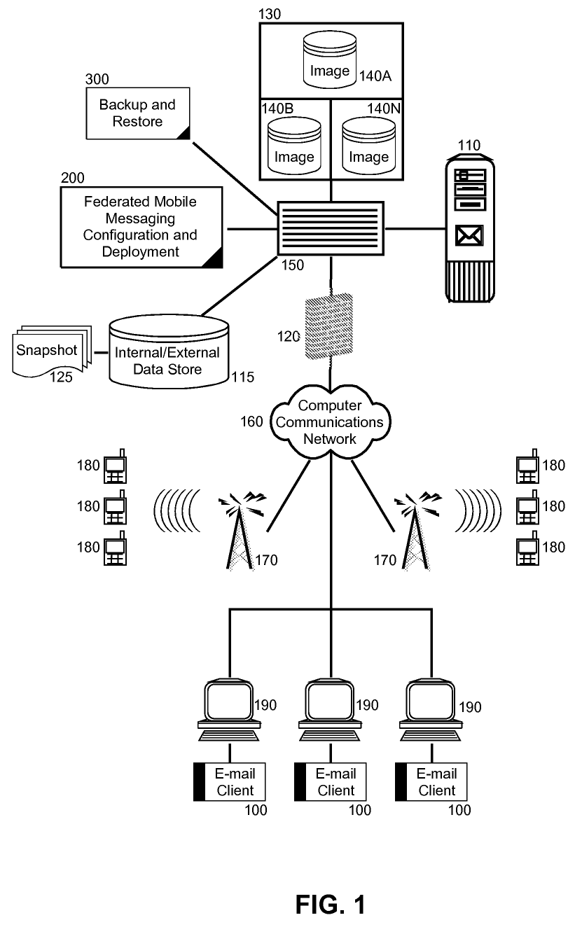

In more particular illustration, FIG. 1 schematically shows a mobile messaging system configured for backup and restore. The system can include a mail server 110 configured for communicative coupling through optional firewall 120 over computer communications network 160 to different e-mail clients 100 each hosted in a corresponding host computing device 190. The system also can include a federated mobile messaging appliance 150. The federated mobile messaging appliance 150 can include one or more hidden partitions 130 in fixed storage. The hidden partition 130 can include different images 140A, 140B, 140N of a mobile messaging system each corresponding to a different type of e-mail server. The appliance 150 also can include federated mobile messaging configuration and deployment logic 200.

The federated mobile messaging configuration and deployment logic 200 can include program code enabled to determine any combination of an e-mail server type, version or service level for the e-mail server 110. The program code also can be enabled to activate a given one of the images 140A, 140B, 140N of a mobile messaging system intended for use with the determined e-mail server type and version for the e-mail server 110, while the partition 130 can remain hidden from view. The program code yet further can be enabled to configure the corresponding one of the images 140A, 140B, 140N of the mobile messaging system for operation and to deploy the corresponding one of the images 140A, 140B, 140N of the mobile messaging system to deliver e-mail messages to wireless devices 180 over wireless network 170. In particular, a script of registry settings can be retrieved for the corresponding one of the images 140A, 140B, 140N and the registry settings can be applied to any of the e-mail server 110, the underlying operating system and the corresponding one of the images 140A, 140B, 140N.

Notably, backup and restore logic 300 can be coupled to the federated mobile messaging appliance 150. The backup and restore logic 300 can include program code enabled to periodically store a snapshot 125 of an instance of the execution of the corresponding one of the images 140A, 140B, 140N of the mobile messaging system. The snapshot 125 can be stored in a data store 115, such as an external data store, or within an internal network volume. In either case, the program code of the backup and restore logic 300 further can be enabled to restore a given snapshot 125 on demand in order to restore the state of the corresponding one of the images 140A, 140B, 140N of the mobile messaging system to a state prior to a system failure or configuration change.

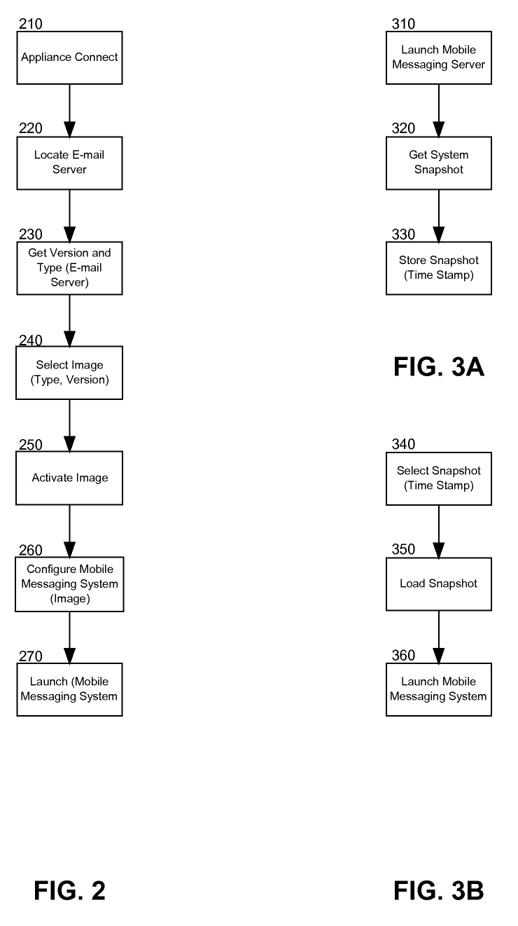

In further illustration of the operation of the federated mobile messaging configuration logic 200, FIG. 2 is a flow chart illustrating a process for the federated configuration and deployment of a mobile messaging system. The process can begin in block 210 with the communicative connection of the appliance into a network coupled to an e-mail server. In block 220, the e-mail server in the network can be located and in block 230, a version and type of the e-mail server can be determined by way of an call to an exposed method in an application programming interface (API) to the e-mail server.

In block 240, an image of the mobile messaging system residing in a hidden partition in the appliance and associated with the e-mail server type and version can be selected. Thereafter, in block 250 the selected image can be activated (while other images in the hidden partition in the appliance can remain dormant). Once an image has been selected and activated, in block 260 the selected image of the mobile messaging system can be configured for deployment in the network. For example, in block 260A one or more mobile messaging system rules can be established such as the way in which the mobile messaging system provides wireless delivery of a message received in the e-mail server. Additionally, in block 260B, a STIG checklist can be rendered to ensure the sufficient hardening of the mobile messaging system to comply with STIG configuration standards. Finally, in block 270, once configured the mobile messaging system can be launched for operation in conjunction with the e-mail server.

Turning now to FIG. 3A, once the mobile messaging system has been launched for operation, periodically, the state of the mobile messaging system can be stored as a snapshot in order to permit subsequent restoration of the state of the mobile messaging system preceding a system destabilizing event or an unwanted configuration change. In this regard, in block 310 the mobile messaging server can be launched and in block 320 a system snapshot can be acquired, for example by copying the content of memory associated with the mobile messaging server along with configuration settings for the mobile messaging server. Finally, in block 330 the snapshot can be stored in association with a time stamp, date stamp or both. Of note the foregoing process can be repeatedly applied so as to provide a catalog of different snapshots of different states of the mobile messaging server.

Turning next to FIG. 3B, a previously stored snapshot can be retrieved in order to restore a prior state of the mobile messaging system. Specifically, in block 340 a snapshot can be selected according to time stamp, date stamp or both. In block 350 the snap shot can be loaded including the configuration settings for the mobile messaging server and the content of memory associated with the mobile messaging server. Thereafter, in block 360 the mobile messaging system can be launched thereby producing an executing instance of a prior state of the mobile messaging system.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. In a federated mobile messaging appliance, a method for backup and restore in a mobile messaging system, the method comprising:
deploying a mobile messaging system for use in cooperation with a communicatively coupled e-mail server;
pushing e-mail from the e-mail server to wireless devices belonging to different subscribers through the mobile messaging system;
acquiring a snapshot of the deployed mobile messaging system exemplary of a contemporaneous state of the mobile messaging system; and,
storing the snapshot for subsequent retrieval and restoration of a subsequently prior state of the mobile messaging system.

2. A federated mobile messaging appliance comprising:
a hidden partition comprising a plurality of images of a mobile messaging system each of the images corresponding to a particular e-mail server type;
federated mobile messaging configuration logic comprising program code enabled to identify an e-mail server type for a coupled e-mail server, to select one of the images based upon the identified e-mail server type, and to configure and activate a corresponding mobile messaging system for the selected one of the images for interoperation with the coupled e-mail server; and,
backup and restore logic comprising program code enabled to acquire a snapshot of the deployed mobile messaging system exemplary of a contemporaneous state of the mobile messaging system, and to store the snapshot for subsequent retrieval and restoration of a subsequently prior state of the mobile messaging system.

3. A computer program product comprising a computer usable medium embodying computer usable program code for subscriber auditing in a mobile messaging system in an appliance, the computer program product comprising:
computer usable program code for deploying a mobile messaging system for use in cooperation with a communicatively coupled e-mail server;
computer usable program code for pushing e-mail from the e-mail server to wireless devices belonging to different subscribers through the mobile messaging system;
computer usable program code for acquiring a snapshot of the deployed mobile messaging system exemplary of a contemporaneous state of the mobile messaging system; and,
computer usable program code for storing the snapshot for subsequent retrieval and restoration of a subsequently prior state of the mobile messaging system.
